(19) United States
(12) Patent Application Publication
(10) Pub. No.: US 2023/0239793 A1
(43) Pub. Date: Jul. 27, 2023

(54) POWER SAVING ENHACENMENT FOR SIDELINK (SL) COMMUNICATION

(71) Applicant: MEDIATEK INC., Hsinchu City (TW)

(72) Inventors: Guan-Yu LIN, Hsinchu City (TW); Tao CHEN, Beijing (CN); Ahmet Umut UGURLU, Cambridge (GB); Ming-Yuan CHENG, Hsinchu City (TW)

(21) Appl. No.: 18/003,772

(22) PCT Filed: Aug. 3, 2021
(86) PCT No.: PCT/CN2021/110205

§ 371 Date: Dec. 29, 2022

(30) Foreign Application Priority Data
Aug. 7, 2020 (WO) PCT/CN2020/107820

(51) Int. Cl. H04W 52/02

(52) U.S. Cl. CPC H04W 52/0229; H04W 52/0216; H04W 52/0219

(57) ABSTRACT

A method for supporting Sidelink (SL) Discontinuous Reception (DRX) operation is provided. A User Equipment (UE) maintains SL DRX configuration which includes one of a transmission pattern and a reception pattern that the UE expects to perform transmission and reception to a peer UE. The UE exchanges the SL DRX configuration with the peer UE. Based on the exchange of the SL DRX configuration, the UE determines when to perform transmission or reception to or from the peer UE during an SL DRX operation. Based on the determination, the UE performs transmission or reception to or from the peer UE during the SL DRX operation.

### CROSS REFERENCE TO RELATED APPLICATIONS

This Application claims priority of International Application No. PCT/CN2020/107820, filed on Aug. 7, 2020, the entirety of which is incorporated by reference herein.

### FIELD OF THE INVENTION

The application generally relates to mobile communications and, more particularly, to power saving enhancement for Sidelink (SL) communication.

### BACKGROUND OF THE INVENTION

In a typical mobile communication environment, User Equipment (UE) (also called Mobile Station (MS)), such as a mobile telephone (also known as a cellular or cell phone), or a tablet Personal Computer (PC) with wireless communications capability, may communicate voice and/or data signals to one or more service networks. The wireless communications between the UE and the service networks may be performed using various Radio Access Technologies (RATs), such as Global System for Mobile communications (GSM) technology, General Packet Radio Service (GPRS) technology, Enhanced Data rates for Global Evolution (EDGE) technology, Wideband Code Division Multiple Access (WCDMA) technology, Code Division Multiple Access 2000 (CDMA-2000) technology, Time Division-Synchronous Code Division Multiple Access (TD-SCDMA) technology, Worldwide Interoperability for Microwave Access (WiMAX) technology, Long Term Evolution (LTE) technology, LTE-Advanced (LTE-A) technology, etc.

These RATs have been adopted for use in various telecommunication standards to provide a common protocol that enables different wireless devices to communicate on a municipal, national, regional, and even global level. An example of an emerging telecommunication standard is the 5G New Radio (NR). The 5G NR is a set of enhancements to the LTE mobile standard promulgated by the Third Generation Partnership Project (3GPP). It is designed to better support mobile broadband Internet access by improving spectral efficiency, reducing costs, and improving services.

In LTE and 5G NR, device-to-device (D2D) communication is supported to allow two or more UEs to directly communicate with one other. This D2D communication may also be referred to as Sidelink (SL) communication, and it may be applied to vehicular communication services which is also known as Vehicle-to-Everything (V2X) services. V2X collectively refers to communication technology via all interfaces with vehicles, including Vehicle-to-Vehicle (V2V), Vehicle-to-Infrastructure (V2I), Vehicle-to-Person (V2P), and Vehicle-to-Network (V2N).

Particularly, according to release 16 of the 3GPP specifications for NR-based V2X, traffic with diverse Quality of Service (QoS) requirement is supported and a UE is allowed to transmit/receive traffic delivered by unicast, groupcast, and broadcast simultaneously. Although with significant enhancement over the LTE-based V2X, current NR-based V2X design has not yet introduced any power saving related mechanism. Since a UE does not know when other UEs will try to communicate with it, the UE needs to monitor Sidelink Control Information (SCI) continuously over the PC5 interface even though there may not be any peer UE nearby. Disadvantageously, the continuous SCI monitoring over the PC5 interface will result in significant power consumption of the V2X UE.

Moreover, in NR-based V2X, if mode-1 resource scheduling (i.e., SL resource scheduled by network) is applied, the radio resources for new transmission and re-transmission are scheduled by the network. That is to say, in case there may be upcoming SL traffic, the UE needs to keep monitoring on the Uu interface for receiving SL grant scheduling from the network, and disregards the power saving rules currently in use on the Uu interface. Similarly, the continuous monitoring over the Uu interface will degrade the power saving performance on the Uu interface.

Therefore, it is desirable to have a robust and efficient power saving mechanism for NR-based V2X.

### SUMMARY OF THE INVENTION

The present application proposes a power saving mechanism for NR-based V2X, in which a Discontinuous Reception (DRX)-like operation is introduced for SL communication.

In one aspect of the application, a method is provided. The method comprises the following steps: maintaining SL DRX configuration by a User Equipment (UE), wherein the SL DRX configuration comprises one of a transmission pattern and a reception pattern that the UE expects to perform transmission and reception to a peer UE; exchanging the SL DRX configuration with the peer UE; based on the exchange of the SL DRX configuration, determining when to perform transmission or reception to or from the peer UE during an SL DRX operation; and based on the determination, performing transmission or reception to or from the peer UE during the SL DRX operation.

In another aspect of the application, a UE comprising a wireless transceiver and a controller is provided. The wireless transceiver is configured to perform transmission and reception to and from a peer UE. The controller is coupled to the wireless transceiver, and is configured to: maintain SL DRX configuration comprising one of a transmission pattern and a reception pattern that the UE expects to perform transmission and reception to a peer UE; exchange the SL DRX configuration with the peer UE via the wireless transceiver; based on the exchange of the SL DRX configuration, determine when to perform transmission or reception to or from the peer UE during an SL DRX operation; and based on the determination, performing transmission or reception to or from the peer UE via the wireless transceiver during the SL DRX operation.

Other aspects and features of the present application will become apparent to those with ordinarily skill in the art upon review of the following descriptions of specific embodiments of the UEs and the methods for supporting SL DRX operation.

### BRIEF DESCRIPTION OF THE DRAWINGS

The present application can be more fully understood by reading the subsequent detailed description and examples with references made to the accompanying drawings, wherein:

FIG. 1 is a schematic diagram illustrating a cellular communication network according to an embodiment of the application;

FIG. 2 is a schematic diagram illustrating an SL communication environment according to an embodiment of the application;

FIG. 3 is a schematic diagram illustrating an SL communication environment according to another embodiment of the application;

FIG. 4 is a block diagram illustrating a UE according to an embodiment of the application;

FIG. 5 is a schematic diagram illustrating the application of separate SL DRX configurations according to an embodiment of the application;

FIG. 6 is a schematic diagram illustrating determination of the complete SL DRX pattern of a UE according to an embodiment of the application;

FIG. 7 is a flow chart illustrating the method for supporting SL DRX operation according to an embodiment of the application;

FIG. 8 is a schematic diagram illustrating the relation between the sensing pattern and the transmission pattern according to an embodiment of the application;

FIG. 9 is a schematic diagram illustrating the relation between the sensing pattern and the transmission pattern according to another embodiment of the application; and

FIG. 10 is a schematic diagram illustrating exemplary application of a wake-up signal during an SL DRX operation according to an embodiment of the application.

### DETAILED DESCRIPTION

The following description is made for the purpose of illustrating the general principles of the application and should not be taken in a limiting sense. It should be understood that the embodiments may be realized in software, hardware, firmware, or any combination thereof. The terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

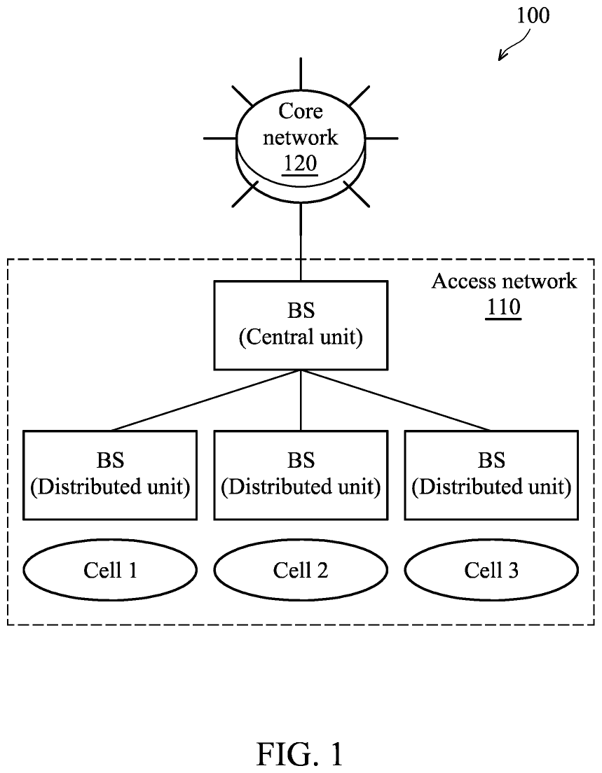

FIG. 1 is a schematic diagram illustrating a cellular communication network according to an embodiment of the application.

As shown in FIG. 1, the cellular communication network 100 may include an access network 110 and a core network 120. The access network 110 may be responsible for processing radio signals, terminating radio protocols, and connecting one or more UEs (not shown) with the core network 120. The core network 120 may be responsible for performing mobility management, network-side authentication, and interfaces with public/external networks (e.g., the Internet).

In one embodiment, the cellular communication network 100 may be a 5G NR network, and the access network 110 and the core network 120 may be a Next Generation Radio Access Network (NG-RAN) and a Next Generation Core Network (NG-CN), respectively.

An NG-RAN may include one or more Base Stations (BSs), such as next generation NodeBs (gNBs), which support high frequency bands (e.g., above 24 GHz), and each gNB may further include one or more Transmission Reception Points (TRPs), wherein each gNB or TRP may be referred to as a 5G BS. Some gNB functions may be distributed across different TRPs, while others may be centralized, leaving the flexibility and scope of specific deployments to fulfill the requirements for specific cases. For example, different protocol split options between central unit and distributed unit of gNB nodes may be possible. In one embodiment, the Service Data Adaptation Protocol (SDAP) layer and the Packet Data Convergence Protocol (PDCP) layer may be located in the central unit, while the Radio Link Control (RLC) layer, the Medium Access Control (MAC) layer, and the Physical (PHY) layer may be located in the distributed units.

A 5G BS may form one or more cells with different Component Carriers (CCs) for providing mobile services to UEs. For example, a UE may camp on one or more cells formed by one or more gNBs or TRPs, wherein the cells which the UE is camped on may be referred to as serving cells.

A NG-CN generally consists of various network functions, including Access and Mobility Function (AMF), Session Management Function (SMF), Policy Control Function (PCF), Application Function (AF), Authentication Server Function (AUSF), User Plane Function (UPF), and User Data Management (UDM), wherein each network function may be implemented as a network element on a dedicated hardware, or as a software instance running on a dedicated hardware, or as a virtualized function instantiated on an appropriate platform, e.g., a cloud infrastructure.

The AMF provides UE-based authentication, authorization, mobility management, etc. The SMF is responsible for session management and allocates Internet Protocol (IP) addresses to UEs. It also selects and controls the UPF for data transfer. If a UE has multiple sessions, different SMFs may be allocated to each session to manage them individually and possibly provide different functions per session. The AF provides information on the packet flow to PCF responsible for policy control in order to support Quality of Service (QoS). Based on the information, the PCF determines policies about mobility and session management to make the AMF and the SMF operate properly. The AUSF stores data for authentication of UEs, while the UDM stores subscription data of UEs.

It should be understood that the cellular communication network 100 described in the embodiment of FIG. 1 is for illustrative purposes only and is not intended to limit the scope of the application. For example, the RAT utilized by the cellular communication network 100 may be a legacy technology, such as the LTE, LTE-A, or TD-LTE technology, or may be a future enhancement of the 5G NR technology, such as the 6G technology.

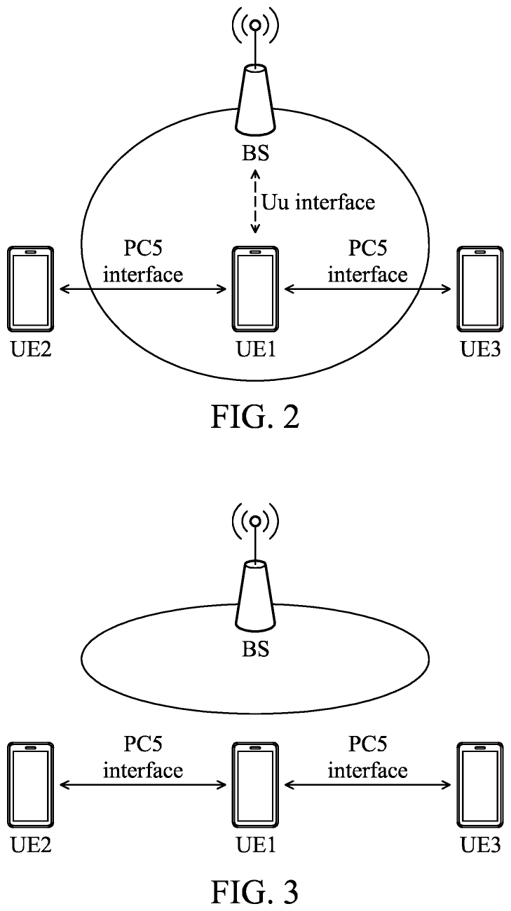

FIG. 2 is a schematic diagram illustrating an SL communication environment according to an embodiment of the application.

As shown in FIG. 2, UE1 is located within the radio coverage of the BS and is able to communicate with the BS over the Uu interface, while UE2 and UE3 are out of the radio coverage of the BS. In addition to supporting the Uu interface, UE1 also supports the PC5 interface for SL communication with UE2 and UE3.

Specifically, UE1 may operate as a scheduler UE (or called relay UE) which schedules/allocates the radio resources for UE2 and UE3 (or called scheduled UEs) according to the configuration received from the BS or pre-defined in the 3GPP specifications for NR-based V2X. As a relay, UE1 may forward traffic between UE2 and UE3, and/or forward traffic between UE2/UE3 and the BS. For example, UE1 may be configured as a Layer 2 relay or a Layer 3 relay. Alternatively, UE1 may not operate as a relay, and may initiate direct SL communication with either one or both of UE2 and UE3.

Please note that the 3GPP specifications mentioned herein are used to teach the spirit of the application, and the application should not be limited thereto.

FIG. 3 is a schematic diagram illustrating an SL communication environment according to another embodiment of the application.

As shown in FIG. 3, none of UE1˜UE3 is located within the radio coverage of the BS, but SL communication between UE1˜UE3 is possible over the PC5 interface.

Specifically, UE1 may operate as a scheduler UE (or called relay UE) which schedules/allocates the radio resources for UE2 and UE3 (or called scheduled UEs) according to the configuration pre-defined in the 3GPP specifications for NR-based V2X or the configuration previously received from the BS when UE1 was camped on the BS. As a relay, UE1 may forward traffic between UE2 and UE3. For example, UE1 may be configured as a Layer 2 relay or a Layer 3 relay. Alternatively, UE1 may not operate as a relay, and may initiate direct SL communication with either one or both of UE2 and UE3.

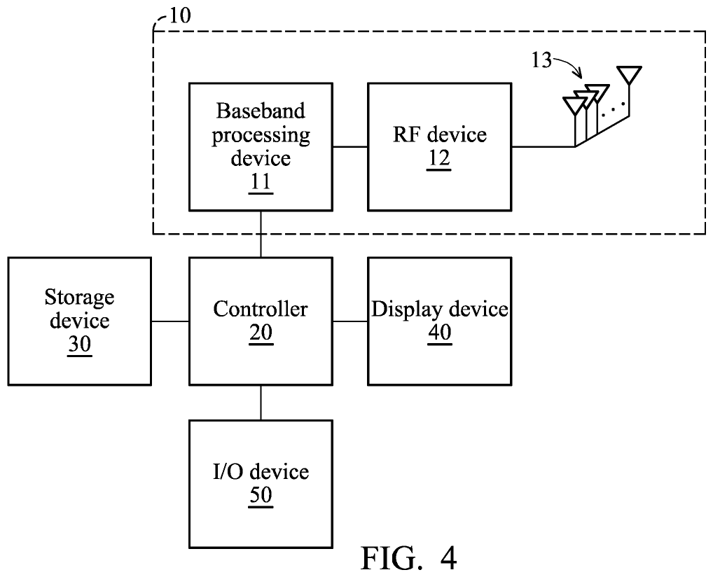

FIG. 4 is a block diagram illustrating a UE according to an embodiment of the application.

As shown in FIG. 4, a UE (e.g., a Transmitter (Tx) UE or Receiver (Rx) UE) may include a wireless transceiver 10, a controller 20, a storage device 30, a display device 40, and an Input/Output (I/O) device 50.

The wireless transceiver 10 is configured to perform wireless transmission and reception to and from other UEs and/or the BS(s) of the access network 110.

Specifically, the wireless transceiver 10 may include a baseband processing device 11, a Radio Frequency (RF) device 12, and antenna 13, wherein the antenna 13 may include an antenna array for beamforming.

The baseband processing device 11 is configured to perform baseband signal processing and control the communications between subscriber identity card(s) (not shown) and the RF device 12. The baseband processing device 11 may contain multiple hardware components to perform the baseband signal processing, including Analog-to-Digital Conversion (ADC)/Digital-to-Analog Conversion (DAC), gain adjusting, modulation/demodulation, encoding/decoding, and so on.

The RF device 12 may receive RF wireless signals via the antenna 13, convert the received RF wireless signals to baseband signals, which are processed by the baseband processing device 11, or receive baseband signals from the baseband processing device 11 and convert the received baseband signals to RF wireless signals, which are later transmitted via the antenna 13. The RF device 12 may also contain multiple hardware devices to perform radio frequency conversion. For example, the RF device 12 may comprise a mixer to multiply the baseband signals with a carrier oscillated in the radio frequency of the supported RAT(s), wherein the radio frequency may be any radio frequency (e.g., 30 GHz˜300 GHz for mmWave) utilized in the 5G NR technology, or may be 900 MHz, 2100 MHz, or 2.6 GHz utilized in LTE/LTE-A/TD-LTE technology, or another radio frequency, depending on the RAT in use.

The controller 20 may be a general-purpose processor, a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the wireless transceiver 10 for wireless communication with the service network 120, storing and retrieving data (e.g., program code) to and from the storage device 30, sending a series of frame data (e.g. representing text messages, graphics, images, etc.) to the display device 40, and receiving user inputs or outputting signals via the I/O device 50.

In particular, the controller 20 coordinates the aforementioned operations of the wireless transceiver 10, the storage device 30, the display device 40, and the I/O device 50 for performing the method of the present application.

In another embodiment, the controller 20 may be incorporated into the baseband processing device 11, to serve as a baseband processor.

As will be appreciated by persons skilled in the art, the circuits of the controller 20 will typically include transistors that are configured in such a way as to control the operation of the circuits in accordance with the functions and operations described herein. As will be further appreciated, the specific structure or interconnections of the transistors will typically be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 30 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data, instructions, and/or program code of applications, communication protocols, and/or the method of the present application. For example, the communication protocols may include a 5G NR protocol stacks which includes a Non-Access-Stratum (NAS) layer to communicate with an AMF/SMF/MME entity connecting to the core network 120, a Radio Resource Control (RRC) layer for high layer configuration and control, a Packet Data Convergence Protocol/Radio Link Control (PDCP/RLC) layer, a Media Access Control (MAC) layer, and a Physical (PHY) layer.

The display device 40 may be a Liquid-Crystal Display (LCD), a Light-Emitting Diode (LED) display, an Organic LED (OLED) display, or an Electronic Paper Display (EPD), etc., for providing a display function. Alternatively, the display device 40 may further include one or more touch sensors disposed thereon or thereunder for sensing touches, contacts, or approximations of objects, such as fingers or styluses.

The I/O device 50 may include one or more buttons, a keyboard, a mouse, a touch pad, a video camera, a microphone, and/or a speaker, etc., to serve as the Man-Machine Interface (MMI) for interaction with users.

It should be understood that the components described in the embodiment of FIG. 4 are for illustrative purposes only and are not intended to limit the scope of the application.

For example, a UE may include more components, such as a power supply, and/or a Global Positioning System (GPS) device, wherein the power supply may be a mobile/replaceable battery providing power to all the other components of the UE, and the GPS device may provide the location information of the UE for use by some location-based services or applications. Alternatively, a UE may include fewer components. For example, the UE may not include the display device 40 and/or the I/O device 50.

### Legacy DRX Operation for the Uu Interface

In legacy cellular communication, to reduce the power consumption for a UE to monitor the Physical Downlink Control Channel (PDCCH) continuously even when the UE has no traffic to transmit or receive to or from the network, the network may configure the UE with a DRX configuration. In 5G NR, a DRX configuration includes several timers and counters to define when the UE should turn on its radio to monitor the PDCCH for possible scheduling, i.e., the DRX active time. For those times not within the DRX active time, the UE does not need to monitor the PDCCH and thus, can turn off the radio for power saving. The BS and the UE should have aligned understanding on the DRX active time, and thus, the BS communicates with the UE only when the UE is in its DRX active time.

To be specific, in NR Rel-15, three parameters, including i.e., DRX offset, DRX cycle, and DRX on duration, are used to define the UE's basic on-off pattern in a DRX operation. The DRX cycle refers to the period of each on-off pattern. For example, if the DRX cycle is 10 milliseconds (ms) long, it means that the on-off pattern will repeat per 10 ms. The starting time of each DRX cycle is determined by the DRX offset (more specifically, start offset and slot offset). In the start of each DRX cycle, a UE should turn on its radio to monitor the PDCCH for a period of time is defined by the DRX on duration and controlled by a DRX on duration timer. If the UE does not receive any PDCCH data before the DRX on duration timer expires, UE can turn off its radio to save power until the end of the DRX cycle and resume PDCCH monitoring in the start of the next DRX cycle. In summary, the three parameters define the timing and duration that a UE should monitor the PDCCH when there is no PDCCH data sent by the BS to schedule Downlink (DL) or Uplink (UL) transmission.

In cases where there is traffic activity when DRX is configured, a UE may need to keep awake for more time (i.e., the DRX active time may be extended) to perform possible data transmission and reception. For example, if the UE receives PDCCH data scheduling new transmission for UL/DL transmission, the DRX inactivity timer is started/restarted, and when the DRX inactivity timer is running, the UE should always monitor the PDCCH. The reason is that a new transmission is ongoing, and in response, the UE should keep awake to see if there is more traffic following current new transmission, i.e., bursty traffic arrival.

In addition, considering that a UE needs to send/receive Hybrid Automatic Repeat reQuest (HARQ) re-transmission, an HARQ Round-Trip Time (RTT) timer and an HARQ re-transmission timer are defined for each UL/DL HARQ process. The intention is that for UL, when the UE sends an UL packet, the network may need some time (i.e., the time controlled by the HARQ RTT timer) to prepare scheduling for HARQ re-transmission, which means the network will not schedule any UL re-transmission for the same HARQ process. Therefore, the UE may go to sleep (e.g., turn off its radio) when the UL HARQ RTT timer is running, and after the UL HARQ RTT timer expires, the UE may wake up to monitor the PDCCH for possible UL grant scheduling for HARQ retransmission when the HARQ re-transmission timer is running. If the UE does not receive any UL grant scheduling for HARQ re-transmission during the HARQ re-transmission timer is running, the UE may consider that the network does not intend to send UL grant for HARQ re-transmission for this HARQ process, and thus, the UE may go to sleep again. For DL, the mechanism of the DL HARQ RTT timer and HARQ re-transmission apply similar concept.

### SL DRX Operation for the PC5 Interface

In NR Rel-16, the power saving mechanism is not yet introduced for SL communication. That is, when a UE activates SL communication for NR-V2X, the UE should keep monitoring all SL Rx resource pools for possible SL transmission which may happen in any time. This continuous monitoring task inevitably causes significant power consumption of the UE. In order to solve this problem, the present application proposes to apply a DRX-like mechanism in the PC5 interface for SL communication, to reduce unnecessary power consumption for Sidelink Control Information (SCI) monitoring.

To enable discontinuous SCI monitoring while ensuring normal SL communication, a UE needs to know when to communicate with its peer UE, i.e., to know if its peer UE is in active time. Otherwise, a UE may try to perform SL communication with its peer UE, while the peer UE may have turned off its radio for power saving. As a result, the SL communication attempt may fail (e.g., due to no response from the peer UE), and the UE may need to perform HARQ re-transmission. Therefore, some coordination is required for a UE to know SL DRX configuration of its peer UE. The principle for the coordination of the SL DRX operation is to ensure that when a transmitter UE is transmitting, the receiving UE is awake to monitor for possible SL data reception.

In the present application, each UE may maintain its SL DRX configuration which may include a transmission pattern and/or a reception pattern that the UE expects to perform transmission and/or reception to a peer UE, and exchange the SL DRX configuration with the peer UE. Based on the exchange of the SL DRX configuration, the UE may determine when to perform transmission or reception to or from the peer UE during an SL DRX operation. Based on the determination, the UE may perform transmission or reception to or from the peer UE during the SL DRX operation.

The transmission pattern may include information indicative of specific time-frequency radio resources that the UE uses to perform transmission to the peer UE. For example, the information may include a timing offset for SL DRX (also called an SL DRX offset, including an SL DRX start offset and/or an SL DRX slot offset), a transmission pattern per repetition cycle (e.g., specified by a duration for transmission located in the beginning of each repetition cycle) (also called an SL DRX-ON duration), and a repetition cycle length (also called an SL DRX cycle). In one embodiment, the transmission pattern can be kind of SL configured grants, or periodically reserved resource.

After receiving a transmission pattern from a peer UE, a UE may keep awake to monitor for possible transmission from the peer UE. In other words, the UE may keep awake to monitor all time-frequency radio resources indicated by any peer UE as part of transmission pattern. If a UE has multiple peer UEs, a UE may monitor the superposition of transmission patterns of all peer UEs. Please note that if this UE has no data for transmission or retransmission, and if no data from peer UE is expected (i.e., current slot is not within the transmission pattern of any peer UE), then this UE can turn off its radio for power saving even if the current slot is within the transmission pattern of this UE. In other words, the UE may skip its own transmission opportunity, specified by its own transmission pattern, to its peer UE if there is no data to be transmitted to the peer UE. In other words, the transmitter UE determines when the receiver UE should keep awake to monitor SCI for possible traffic from the transmitter UE. Equivalently, we can say that the transmitter UE determines the SL DRX configuration for the receiver UE to determine its reception pattern, i.e., when the receiver UE should keep awake for monitoring SCI and corresponding PSSCH transmission from this transmitter UE.

The reception pattern may include information indicative of specific time-frequency radio resources that the UE uses to perform reception form the peer UE. For example, the information may include a timing offset for SL DRX (also called an SL DRX offset, including an SL DRX start offset and/or an SL DRX slot offset), a transmission pattern per repetition cycle (e.g., specified by a duration for transmission located in the beginning of each repetition cycle) (also called an SL DRX-ON duration), and a repetition cycle length (also called an SL DRX cycle). In one embodiment, the reception pattern can be kind of SL configured grants, or periodically reserved resource UE expects the peer UE (Tx UE) to use.

In cases where the SL DRX configuration received from the peer UE includes a transmission pattern, a Rx UE may keep awake to monitor the transmission resources for possible data reception from the peer UE (Tx UE). In addition, a Rx UE should monitor re-transmission resource reserved by Tx UE through SCI unless the re-transmission resource would not be used (e.g., the Transport Block (TB) transmission is terminated due to successful decoding). A Rx UE should monitor the re-transmission resource even if the re-transmission resource is outside the set of transmission resources indicated in the SL DRX configuration of the Tx UE.

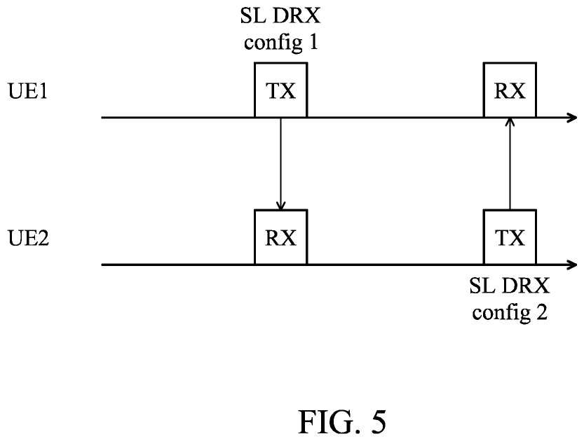

Considering asymmetric traffic flow (i.e., the traffic characteristic from UE A to peer UE B is different from that from peer UE B back to UE A), it is more flexible for a UE to maintain separate SL DRX configurations for transmission and for reception. FIG. 5 is a schematic diagram illustrating the application of separate SL DRX configurations according to an embodiment of the application. As shown in FIG. 5, UE A applies the SL DRX configuration 1 to determine when to transmit to UE B, while UE B applies the SL DRX configuration 2 to determine when to transmit to UE A. Therefore, UE A applies the SL DRX configuration 1 for transmission to UE B and applies the SL DRX configuration 2 for reception from UE B; while UE B applies the SL DRX configuration 1 for reception from UE A and applies the SL DRX configuration 2 for transmission to UE A.

In addition to the SL DRX configuration (with transmission pattern and/or reception pattern), a Rx UE may further determine an additional and/or aperiodic DRX-ON duration or SL active time according to the resource reservation in the SCI received from the Tx UE. For example, in addition to monitoring the resources indicated in the SL DRX configuration, the Rx UE may also monitor the reserved resources indicated by the SCI received from the Tx UE. Therefore, the Tx UE may just impose the restriction on some transmissions following the DRX-ON pattern, e.g., when the transmission resources are not reserved by the SCI (e.g., initial/first transmission without reservation by SCI) and/or when SCI reception for the reserved resources are failed at the Rx UE. The transmissions with resources reserved by previous SCI successfully received by the Rx UE may occur at any time, with no need to follow the SL DRX-ON duration derived from the (pre-)configured transmission and/or reception pattern. The Tx UE may check HARQ feedback to determine whether the Rx UE has successfully received the SCI with resource reservation. If the Rx UE fails to receive the SCI with resource reservation, the Tx UE may need to reselect the resources within the SL DRX-ON duration. If the Rx UE successfully receives the SCI with resource reservation, the Rx UE may select the resources according to the reservation in the SCI, regardless of whether the transmission falls into the SL DRX-ON duration. This is also beneficial for mode 1 resource allocation in which the radio resources are controlled by the BS. Additionally, this SCI-based resource reservation scheme may be enabled or disabled by (pre-)configuration per resource pool and/or per resource allocation mode (mode 1 or mode 2 resource allocation).

Alternatively, the SL DRX configuration (transmission pattern and/or reception pattern) may be per resource pool and/or per cast type. For example, the transmission pattern may be (pre-)configured per resource pool especially for broadcast/groupcast services, so that all UEs in the resource pool should follow the common transmission and/or reception pattern for broadcast/groupcasts communication.

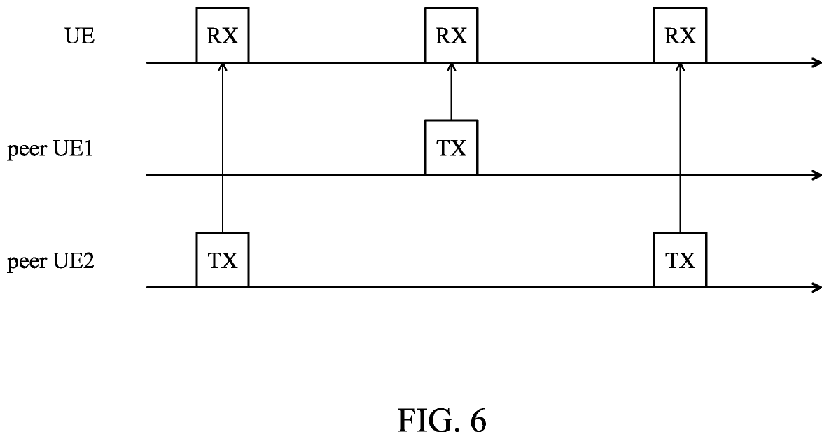

FIG. 6 is a schematic diagram illustrating determination of the complete SL DRX pattern of a UE according to an embodiment of the application. A UE should monitor the superposition of all transmission patterns from all its peer UEs. As shown in FIG. 6, the UE should monitor all the periodicities indicated by the transmission patterns from all its peer UEs (i.e., peer UE1 and peer UE2).

If the SL DRX configuration includes a reception pattern, then after a UE receives specific reception resource set from its peer UE, which indicates the time its peer UE would keep awake for reception, the UE considers those indicated reception resource with a higher priority for SL data transmission, and considers the remaining reception resource with a lower priority for SL data transmission. In one embodiment, the UE cannot use low-priority transmission resource for a new transmission or re-transmission of a MAC PDU to its peer UE. In another embodiment, the UE cannot use low-priority transmission resource for a new transmission, but the UE can use low-priority transmission resource for re-transmission.

To handle bursty data arrival, the transmission pattern and/or the reception pattern may be extended on demand. For example, a Tx UE may consider future transmission resource close to the latest new transmission (e.g., the duration to determine whether it is close enough can be determined by a timer or a configured time gap) as high-priority transmission resource, and this means that as long as the Tx UE performs a new transmission with the duration since the latest new transmission, the Tx UE may extend the SL DRX active time beyond the transmission pattern for this repetition cycle. Specifically, the mentioned new transmission may be dedicated for TB new transmission or may refer to both TB new transmission and TB retransmission. Correspondingly, a Rx UE should keep awake for a while after the latest new reception (e.g., the duration of the additional awake time can be determined by a timer or a configured time gap). Specifically, the mentioned new reception may be dedicated for TB new transmission or may refer to both TB new transmission and TB retransmission. If a Rx UE keeps receiving new data with an interval shorter than the duration since the last new data reception, the Rx UE may keep extending its SL DRX active time as well.

In one embodiment, the extended duration of the SL DRX active time can be modelled by an inactivity timer. The inactivity timer can be restarted whenever a UE transmit or receive data for a new TB transmission or for both a new TB transmission and a TB re-transmission. The extended duration ends when the corresponding inactivity timer expires. In one embodiment, the transmission/reception pattern may or may not be impacted by the inactivity timer. However, as long as the inactivity timer is running, the UE should keep awake for possible transmission/reception.

In one embodiment, a UE may maintain separate inactivity timers for transmission and reception. The configuration of the inactivity timers may be part of the SL DRX configuration and may be exchanged with all peer UEs. In one example, if the SL DRX configuration of a Tx UE includes a transmission pattern of this UE, the SL DRX configuration may include the value of the inactivity timer for data transmission. With the configuration of the inactivity timer, the Rx UE (i.e., the peer UE) may know that the UE will not send more data if the duration since the last new transmission has exceeds the value of inactivity timer indicated by the Tx UE. In one example, if the SL DRX configuration of a Rx UE includes a reception pattern of this UE, the SL DRX configuration may include the value of the inactivity timer for data reception. With the configuration of the inactivity timer, the Tx UE (i.e., the peer UE) may know that the Rx UE will stop monitoring for data reception if the duration since the last new reception has exceeds the value of inactivity timer indicated by the Rx UE.

In one embodiment, the inactivity timer may be configured per UE, and this means that a UE may set the same value of a single inactivity timer in the SL DRX configuration towards different peer UEs. In another embodiment, for unicast communications, the inactivity timer may be configured per PC5-RRC connection (i.e., per source-destination pair) or per unicast link; while for groupcast and broadcast communications, the inactivity timer may be configured per groupcast/broadcast service, e.g., UE may maintain separate SL inactivity timer for each L2 destination associated with different groupcast/broadcast service. In another embodiment, different inactivity timers may be maintained separately e.g., for each unicast link, for each groupcast/broadcast service, or for transmission and reception, and the UE should keep awake as long as any one of the inactivity timers is running.

The SL DRX configuration of a UE can be configured according to the QoS requirement of the established SL Radio Bearer (SLRB) from a UE to its peer UE. In one embodiment, the SL DRX configuration can be determined by higher layer (e.g., the V2X layer) based on the QoS requirement (e.g., identified by QoS profile) of those QoS flows and be forwarded to AS layer. Accordingly, in AS layer, a UE applies the SL DRX configuration provided by upper layer. In one embodiment, each QoS flow or SLRB or QoS requirement (e.g., specified by QoS profile) can be mapped to a suitable (part of) SL DRX configuration. Based on the supported QoS flow or SLRB or QoS profile, in AS layer the UE determines a suitable SL DRX configuration, or part of suitable SL DRX configuration (e.g., suitable SL DRX cycle). If there are multiple QoS flow, multiple SL radio bearers, or multiple QoS requirement (QoS profile) to support, UE may apply separate/multiple SL DRX configuration simultaneously for each SL QoS flow, SL radio bearer, or QoS profile. Or, UE may select one SL DRX configuration to satisfy QoS requirement of all QoS flows, SL radio bearers, or QoS profiles, or to support the highest priority or the most latency stringent QoS flow, SLRB, or QoS profile.

In addition to static SL DRX configuration, a UE may configure with its peer UE several SL DRX configurations, and switch between these SL DRX configurations based on traffic arrival status. For example, a UE may use an SL DRX configuration with short latency, when data becomes available from latency-sensitive SLRB or QoS flow.

In one embodiment, when data from latency-sensitive SLRB becomes available, a Tx UE may switch to use an SL DRX configuration with short latency; and when a Rx UE receives data from latency-sensitive SLRB (e.g., data belonging to a SL logical channel associated with latency-sensitive SLRB), the Rx UE may automatically switch to use the SL DRX configuration to support short latency.

In one embodiment, if a Tx UE decides to switch to a different SL DRX configuration for a unicast link or for a groupcast/broadcast service, the Tx UE may send an explicit notification for the new SL DRX configuration (e.g., via SCI or MAC CE or PC5-RRC message, such as RRCReconfigurationSidelink message) to its peer UE(s).

In one embodiment, the Tx UE may use a counter or timer to support fallback switching from short-latency SL DRX configuration to long-latency SL DRX configuration. When a UE decides to fallback to long-latency SL DRX configuration (e.g., does not transmit or receive data for latency-sensitive SLRB for a while), the UE sends the notification of SL DRX configuration change to its peer UE (via SCI, MAC CE, or PC5-RRC message). Upon receiving the message indicating SL DRX configuration change, the Rx UE accordingly switches its SL DRX configuration to align with Tx UE's selection of SL DRX configuration.

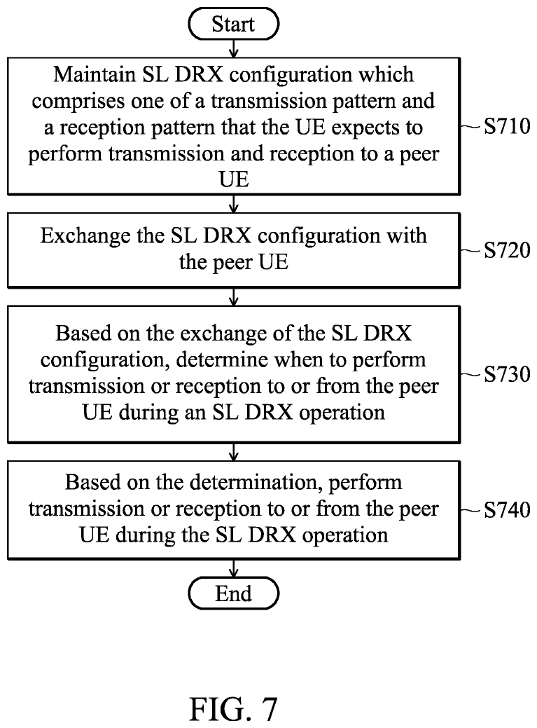

FIG. 7 is a flow chart illustrating the method for supporting SL DRX operation according to an embodiment of the application. In this embodiment, the method may be applied to and executed by any UE participating in SL communication with another UE.

In step S710, the UE maintains SL DRX configuration which comprises one of a transmission pattern and a reception pattern that the UE expects to perform transmission and reception to a peer UE.

In step S720, the UE exchanges the SL DRX configuration with the peer UE.

In step S730, based on the exchange of the SL DRX configuration, the UE determines when to perform transmission or reception to or from the peer UE during an SL DRX operation.

In step S740, based on the determination, the UE performs transmission or reception to or from the peer UE during the SL DRX operation.

### Granularity of SL DRX Configuration

The granularity of the SL DRX configuration may have several alternatives.

For example, for a unicast communication, the SL DRX configuration (with a transmission pattern) may be maintained per unicast link (identified by a source UE ID, a destination UE ID, and a link identifier), or per PC5-RRC connection (identified by a source UE ID and a destination UE ID), or per PC5 QoS flow (each PC5 QoS flow has its own QoS profile which includes the QOS requirements, such as latency requirement, error rate requirement, etc.).

For a groupcast or broadcast communication, the SL DRX configuration (with a transmission pattern) may be maintained per groupcast/broadcast service (identified by destination ID). Alternatively, the SL DRX configuration (with a transmission pattern) may be maintained per UE, which means that the UE may apply a single transmission pattern for transmission to all peer UEs. Alternatively, the SL DRX configuration for a groupcast/broadcast service may follow the SL DRX configuration associated with one or more of the QoS flow, SL radio bearers, or QoS profile used for this groupcast/broadcast service. Alternatively, for a groupcast/broadcast service, some of SL DRX configuration (e,g, slot offset) is configured based on L2 destination ID, while some of SL DRX configurations (such as SL DRX cycle, or SL inactivity timer) are derived from the QoS flow, SL radio bearer, or QoS profile applied by the groupcast/broadcast service.

The SL DRX configuration for groupcast/broadcast services may be statistically configured. In one embodiment, the SL DRX configuration for groupcast/broadcast services may be configured in pre-configuration (e.g., for UEs out of BS' radio coverage). In another embodiment, the SL DRX configuration for groupcast/broadcast services may be configured in the acquired system information (e.g., for UEs operating in the RRC)IDLE/RRC_INACTIVE/RRC_CONNECTED mode). In another embodiment, the SL DRX configuration for groupcast/broadcast services may be configured in dedicated signaling (e.g., for UEs operating in the RRC_CONNECTED mode). If the SL DRX configuration for groupcast/broadcast services is statistically configured, there may be no need for UEs to exchange the SL DRX configuration for groupcast/broadcast services via PC5 signaling. By contrast, for unicast services, a UE may still need to exchange its SL DRX configuration with its peer UE.

### Update of SL DRX Configuration

When a UE has an update on its SL DRX configuration, the UE should inform its peer UE of this change. Without the update information, the peer UE will be unable to find this UE according to the old (outdated) SL DRX configuration of this UE. As a result, the peer UE may consider that an SL Radio Link Failure (RLF) occurs (due to not receiving any HARQ feedback from this UE) and release the PC5-RRC connection with this UE.

An issue regarding update of the SL DRX configuration is that when should this UE apply the new SL DRX configuration after transmitting the new SL DRX configuration to its peer UEs. A UE who changes its SL DRX configuration should ensure that it can be accessed by all peer UEs. In one embodiment, this UE who changes its SL DRX configuration should keep awake according to both the new and old SL DRX configuration until all peer UEs have received the new SL DRX configuration, i.e., this UE can stop monitoring for the old SL DRX configuration only after all peer UEs have received the new SL DRX configuration. In one embodiment, a UE who changes its SL DRX configuration should keep monitoring SCI and/or PSSCH before all its peer UEs have received the new (updated) SL DRX configuration.

In SL relay scenario, a relay UE relays UL and DL traffic for remote UEs. For traffic from the relay UE to the remote UEs (DL relay data), the relay UE may transmit DL relay data to a limited number of remote UEs at a time (due to scheduling capability), and thus, those unscheduled remote UEs may need to keep awake to be scheduled, causing unnecessary waste of power. For traffic from the remote UEs to the relay UE (UL relay data), simultaneous transmission from remote UEs to the relay UE may cause severe collision, when the UL traffic load is heavy. To address this issue of transmission collision and power inefficiency in SL relay scenario when the traffic load is high, several approaches are proposed as follows.

In one embodiment, the remote UEs are classified into several sub-groups. UEs in the same subgroup apply the same SL DRX configuration (with transmission pattern and/or reception pattern). UEs in different subgroups may apply the same SL DRX configuration as well but can perform transmission and/or reception in different time, e.g., with the same or different timing offset for transmission and/or reception cycle. This enables UEs in different subgroups to perform transmission and/or reception in different times, so as to eliminate collision caused by simultaneous transmission. Besides, a remote UE in subgroup 1 does not need to wake up for the transmission time or reception time of other subgroups. Moreover, if the relay UE detects that the traffic load is light, it could dynamically configure several subgroups of remote UEs to use the same timing offset to increase resource utilization.

In one embodiment, the relay UE uses polling message to indicate which remote UEs (in the subgroup) can perform SL transmission for UL relay data. A polled remote UE can transmit, while a non-polled remote UE should wait for transmission after being polled. In one example, a relay UE can send signaling/message to request an SL Buffer Status Report (BSR) from each remote UE, so that the relay UE can poll the remote UEs based on the buffer status information. In one example, each remote UE can send an SL BSR in pre-configured time, e.g., in the beginning of the transmission pattern of the SL DRX cycle of the remote UE. If the traffic load is light, the relay UE can poll all remote UEs (in a specific subgroup) to start their data transmissions. If the traffic load is heavy, the relay UE can poll only some remote UEs (e.g., remote UEs having the highest-priority or most latency-stringent data for relay) at a time. In one example, the relay UE can indicate some remote UEs (in a specific subgroup) to sleep for power saving even though these remote UEs may have data to send, if the relay UE determines that it is not capable of scheduling these remote UEs immediately in this SL DRX cycle due to heavy traffic loading. In one example, the relay UE can poll some remote UEs (in a specific subgroup) to transmit only those data satisfying specific conditions. For example, data allowed to be transmitted is in those logical channels with a specific priority restriction (e.g., priority level above a threshold or with arbitrary value). For example, data allowed to be transmitted is in those logical channels with Bj value in a specific range (e.g., more than a threshold like 0 or with arbitrary value). In one example, the relay UE can further indicate a specific set of time-frequency transmission resources for specific remote UEs (in a specific subgroup) to select for transmission.

In one embodiment, for remote UEs, the transmission pattern and reception pattern may not overlap with each other to avoid the half-duplex loss, i.e., the relay UE cannot receive data when it is transmitting data to a remote UE. In one example, the start time of the transmission pattern of the remote UE (or the start time of the reception pattern of the relay UE for reception of relaying data) is pre-configured. In one example, for remote UE, the reception pattern is just before the transmission time. It means that, for (each subgroup of) remote UEs, the relay UE firstly performs transmission of DL relay data towards remote UEs. After completing transmission of DL relay data, the relay UE sends a polling message to poll one or more remote UEs (in the subgroup) to start transmission of UL relay data. By this way, the duration of the reception pattern and the transmission pattern can be flexible, i.e., if the relay UE finishes the transmission of DL relay data earlier, the remote UE can start transmission of UL relay data earlier.

In one embodiment, in SL relay scenario, the time for the relay UE to transmit to or receive from its upstream relay UE (or gNB) is not overlapped with the time for the relay UE to transmit to or receive from its downstream UE (e.g., a relay UE or a remote UE).

In one embodiment, in SL relay scenario, the DRX-ON duration for the relay UE in the Uu interface is not overlapped with the transmission pattern and/or reception pattern of the relay UE in the PC5 interface to transmit to or receive from its downstream UE which may be a relay UE (e.g. for multi-hop scenario) or a remote UE.

### Access to Peer UE before Exchange of SL DRX Configuration

In an SL DRX operation, a UE may not know the SL DRX configuration of the peer UE before they exchange their SL DRX configurations. That is, before UE A and UE B exchange their SL DRX configurations (e.g., during PC5-RRC connection establishment procedure), if UE B applies SL DRX too early, UE A may not discover UE B because UE A does not know when UE B will monitor PSCCH/Physical Sidelink Shared Channel (PSSCH). As a result, UE A and UE B cannot build PC5-RRC connection due to early SL DRX.

To solve this problem, each UE may be mandated to monitor a specific set of time-frequency radio resources for reception of possible ping/discovery message from peer UEs. The time-frequency radio resources to be monitored by default can be a specific resource pool (e.g., a default resource pool), or a specific bandwidth part (e.g., a default SL bandwidth part), or a specific time duration per cycle (e.g., a default DRX reception pattern for a UE to monitor).

There are different methods to use the default monitoring resources. In one embodiment, a UE monitors the default monitoring resources only when he is not monitoring normal resources (i.e., the time-frequency radio resources for normal SL communication), e.g., for power saving. For example, if a UE cannot find its peer UE by sending a ping/discovery message in normal resources, the UE may assume that its peer UE has already started SL DRX operation, and thus, may switch to send the ping/discovery message on the default monitoring resources to find the peer UE. In another embodiment, a UE always monitors the default monitoring resources, regardless of whether it is performing SL DRX operation or whether it is not monitoring normal resources (i.e., the time-frequency radio resources for normal SL communication), e.g., for power saving. For example, when a UE wants to find its peer UE but has not acquired the SL DRX configuration of its peer UE, the UE can always find the peer UE by sending a ping/discovery message on the default monitoring resources, because each UE always monitors the default monitoring resources.

The default monitoring resources mentioned above may be pre-configured, so that each UE may know the time-frequency locations of the default monitoring resources even if the UE that is being searched for is out of the BS' radio coverage, or even if a peer UE that wants to find this UE is out of the BS' radio coverage.

In one embodiment, the default monitoring resources are shared by all UEs that supports SL communication or SL DRX operation. Since there may be congestion/collision in this default resource pool, to reduce congestion/collision, some transmission limitation may be introduced to the default monitoring resources. In one embodiment, UE A may send a ping/discovery message on the default monitoring resources to find UE B only when UE A does not know the SL DRX configuration of UE B. In another embodiment, the default monitoring resources may only be used for ping/discovery purpose, and cannot be used for normal SL communication. In another embodiment, when a UE receives a ping/discovery message in the default monitoring resources, the UE may exchange the SL DRX configuration with its peer UE. After that, all SL communications between the UEs are performed outside the default monitoring resources.

In one embodiment, the default monitoring resources of a UE can be derived using a formula based on the L2 source ID of the UE. For example, UE A has L2 source ID as ID_A. Then, UE A may need to keep awake to monitor SCI periodically, wherein the periodicity may be a pre-configured/default vale, while the start offset can be derived based on a given formula and ID_A.

In one embodiment, the default monitoring resource for a groupcast/broadcast service can be derived by using a formula based on the L2 destination ID of the groupcast/broadcast service. For example, all UEs running a specific groupcast/broadcast service should periodically monitor SCI periodically, wherein the periodicity of SCI to monitor may be derived from the SL DRX cycle associated with the QoS flow or SL radio bearer or QoS profile of the groupcast/broadcast service, and wherein the start offset of the SCI to monitor can be derived from the L2 destination ID OF the groupcast/broadcast service.

### Partial Sensing before Transmission Operation

To perform SL transmission, a UE may be required to perform sensing on the PSCCH/PSSCH to reduce the probability that the UE selects the same time-frequency radio resource with other UEs for transmission, which may cause collision/interference with/to other UEs. However, if a UE performs an SL DRX operation, the UE may turn off it radio for power saving and thus will not have complete sensing information. Thus, we need to figure out the relation between the pattern of sensing and the transmission pattern of the SL DRX operation, to ensure that the UE may perform transmission without collision/interference with/to other peer UEs.

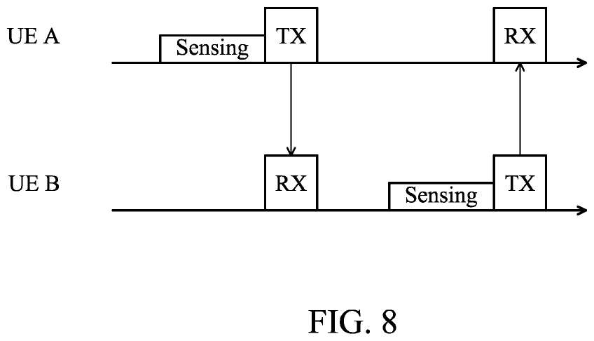

FIG. 8 is a schematic diagram illustrating the relation between the sensing pattern and the transmission pattern according to an embodiment of the application. As shown in FIG. 8, the sensing pattern is located before the transmission pattern to ensure that the UE has enough sensing results for resource selection.

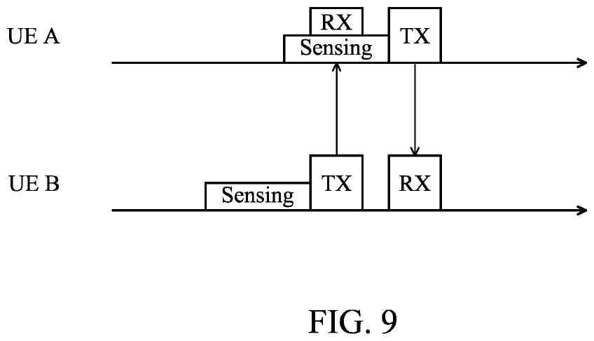

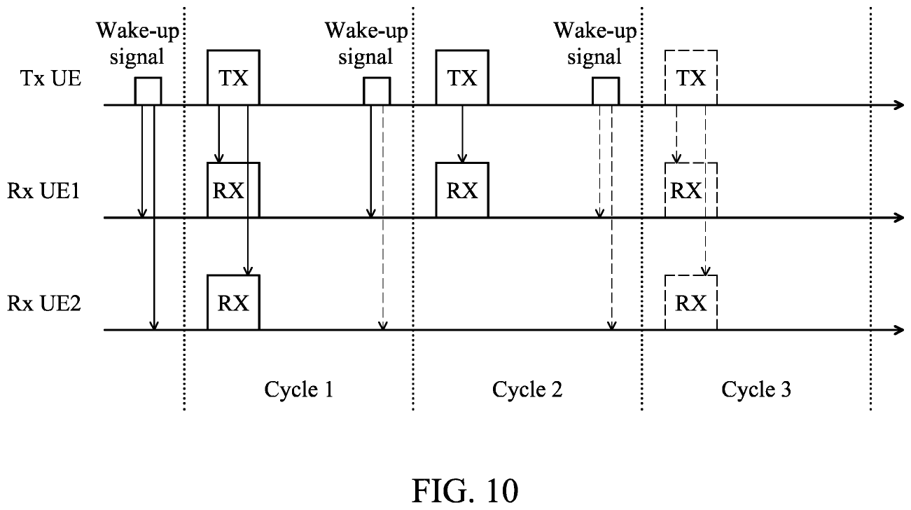

FIG. 9 is a schematic diagram illustrating the relation between the sensing pattern and the transmission pattern according to another embodiment of the application. As shown in FIG. 9, a UE (e.g., UE A) can be configured with the sensing pattern overlapping with the reception pattern. By configuring overlapped patterns for sensing and for reception, power consumption of UE A can be further reduced.

Regarding detailed designs of the partial sensing, the first issue would be the granularity of the sensing pattern of a Tx UE.

In one embodiment, the granularity of the sensing pattern may be per UE. In one example, the sensing pattern is not related to the transmission pattern, and the Tx UE may follow a regular on-off pattern to ensure that the Tx UE can transmit data whenever it wants, or to ensure that the Tx UE can always have small latency to transmit data whenever his data arrives. In one example, the Tx UE may select a per-UE sensing pattern to ensure that the corresponding sensing results can enable the Tx UE to satisfy all QoS requirements of the highest-priority and/or the most latency stringent SL data, and the QoS requirements may be determined by the QoS metric, such as the packet delay budget of all the established QoS flows, SL radio bearers, and/or SL logical channels. In one example, the per-UE sensing pattern may be selected by the UE itself, or may be selected by the UE based on pre-configuration, acquired system information, or dedicated signaling from the network. In one example, the sensing pattern is related to the timing of the latest transmission. For instance, if there is transmission traffic, SCI monitoring is more intensive (i.e., more slots are added into the list for sensing, compared to the default sensing pattern); or otherwise, if there is no transmission traffic, SCI monitoring becomes sparse or is even stopped. In one example, the slots for the UE to monitor may be non-decreasingly changed, if traffic arrival in a given period increases or if the priority of the arriving traffic is high.

In another embodiment, the granularity of the sensing pattern is per link or per PC5-RRC connection. In one example, the Tx UE may have a fixed sensing pattern before the start of the transmission pattern in the SL DRX configuration for each link. This means that the Tx UE should make sure the transmission for a specific link is ready before the start of the transmission pattern for this link. In one example, if a UE exchanges its transmission pattern with its peer UE for SL DRX operation, then the final DRX pattern (or the time that the UE needs to monitor) is the superposition of the transmission patterns of all peer UEs, and the sensing pattern for preparing transmission to each peer UE. In one example, if a UE exchanges its reception pattern with its peer UEs, then the final DRX pattern (or the time that the UE needs to monitor) is the superposition of the reception pattern of this UE and the sensing pattern for preparing transmission to each peer UE. In other words, the sensing pattern should be considered as part of the time for UE to monitor.

The second issue about sensing is whether a UE can skip sensing before the transmission pattern if there is no SL data to be transmitted, e.g., no SL data arrives for a fixed or configurable duration (or time window, or the duration measured by a timer) before the start of the transmission pattern.

In one embodiment, a UE may skip the sensing pattern for SCI monitoring if there is no SL data to be transmitted in the upcoming transmission pattern. This aims to save sensing power more aggressively. In one example, if there is no SL data available for transmission in a fixed or configurable duration (or time window, or the duration measured by a timer) before the start of the transmission pattern, the UE may consider that the transmission for the upcoming transmission pattern probably may not happen, and thus, the UE may cancel the sensing for the upcoming transmission pattern. In another embodiment, a UE may not skip sensing even if there is no SL data available for transmission upon the timing approaching to the start of the transmission pattern. In the previous embodiment, the UE is allowed to skip the sensing pattern for upcoming transmission pattern if there is no SL data to be transmitted in the upcoming transmission pattern, so the UE may have power saving gain. However, another issue is raised regarding how the UE should do if it skips sensing but later on SL data arrives, and several approaches are proposed to address this issue.

In one approach, a UE may just postpone the transmission of late SL data to the transmission pattern of the next repetition cycle.

In one approach, a UE may check whether it can derive enough sensing results (e.g., in a fixed or configuration time duration) before the end of transmission pattern to the peer UE. If so, the UE may perform sensing immediately and send out data before the end of this transmission pattern. Otherwise, if no, the UE may postpone the transmission to the transmission pattern of the next repetition cycle.

In one approach, when late data arrives, a UE may start to perform sensing, and select resource from available candidate resources whenever sensing results for n subframes/slots are available, where n can be a constant or can be configurable by the network through pre-configuration, system information configuration, or dedicated signaling. The value of n can be dependent on the priority of SL data (e.g., the SL logical channel priority of the data) or the (remaining) Packet Delay Budget (PDB) of the SL data. In other words, the UE is allowed to transmit data with less candidate resources for transmission when the SL data to be transmitted has a higher priority or a tighter latency requirement. For example, n may be set to 0, e.g., for extremely high-priority data.

In one approach, a UE may be allowed to perform limited transmission without sufficient sensing results. In one example, before sufficient sensing results are available, the UE can select resource for transmission from an exception resource pool, a resource pool dedicated for partial sensing, or a resource pool for random resource selection. In one example, the UE without sufficient sensing results can transmit with a limited number of transmissions per transmission resource pool, which could be similar to kind of congestion control.

In one approach, there is separate transmission resource pool dedicated for periodic traffic and aperiodic traffic when UE is operating in SL DRX operation. If UE has late periodic traffic, UE postpone it to the next several SL DRX cycle because UE needs more time for sensing results collection. In contrast, if UE has late aperiodic traffic, UE can wake up to collect sensing results, since the time required to collect enough sensing results for transmission is relatively short. In this alternative, each UE cannot send aperiodic traffic in resource pool for periodic traffic, and vice versa.

In one approach, sensing patterns with different periodicities may be selected according to the traffic status, the traffic priority and/or power mode. If there is no traffic and/or the traffic with low priority and/or power saving mode, the large sensing periodicity can be selected. Upon data arrival and/or the traffic with the high priority and/or full power mode, full sensing or the small sensing periodicity can be selected. The traffic priority can be derived according to the priority in SCI or (pre-)configured from the higher layer. The power mode can be derived from the device type and/or (pre-)configuration.

In previous discussion, we discuss the UE behaviors when sensing results are not available. To be specific, the rule to determine whether a UE is able to perform resource selection for transmission may have several criteria.

In one example, a selection window should include candidate resources in N TTI/slots/subframes, or at least should include m candidate resources, wherein N and m may be determined by configuration. N or m may consider all candidate resources or only those candidate resources satisfying a criterion (e.g. RSRP below a threshold).

In one example, each candidate resource has its required sensing results. For example, for candidate resource in slot n, a UE monitors {n−k*reservation period} slots, in which k is an integer and reservation period is to check whether this candidate resource has been reserved by other UEs. For instance, for candidate resource in slot n, a UE monitors [n−k2, n−k1] slots to ensure the candidate resource in slot n is not reserved by other UEs, where k1 and k2 are configured to determine the required sensing window. For example, the candidate resource in slot n is considered with available sensing results, if the UE monitors more than x % slots/TTI in the sensing window [n−k2, n−k1], where x is a configurable parameter. The UE may apply one or more specific sensing pattern to ensure low collision probability of a candidate resource in specific slots/subframes, e.g., a candidate resource is available for selection if all or part of corresponding required sensing pattern had been monitored.

### Resource Selection Requirements

In legacy NR V2X, when packet arrives in slot n, the resource selection window is in the window [n+T1, n+T2], wherein T2 is determined by the minimum T2 and the packet delay budget. Now, when we consider SL DRX operation, T2 is then also dependent on the transmission pattern, i.e., if a UE selects a candidate transmission resource out of the transmission pattern, its peer UE (e.g., a Rx UE) may already turn off its radio for power saving, causing packet reception failure. Here, several approaches are proposed to address this issue.

In one approach, the selected T2 should be within the configured transmission pattern, i.e., T2 is upper bounded by the duration of the transmission pattern in each repetition cycle. If T2 is very close to T1 and the resource selection window [n+T1, n+T2] is too narrow (e.g., smaller than a threshold), the UE may need to postpone transmission to the next repetition cycle.

In another approach, a Tx UE may ensure that its first TB transmission is within the transmission pattern. If a Rx UE receives the first TB transmission within the transmission pattern but fails to decode, the Rx UE may extend the DRX active time to enable reception for TB re-transmission. In other words, the Tx UE does not schedule all new transmission and re-transmission resources before the end of the transmission pattern in current repetition cycle. In one example, if the number of TTI/slot to the end of the transmission pattern is even too short for the Tx UE to select transmission resources for the first transmission of a TB, the Tx UE may postpone the transmission of the TB (e.g., a MAC Protocol Data Unit (PDU)) to the next repetition cycle.

In one embodiment, for mode-1 scheduling, when a transmitter UE has SL grant to transmit, the transmitter UE only consider those destination UEs in SL active time to transmit.

### Further Power Saving with Wake-Up/Go-to-Sleep Signal

To further reduce SL power consumption, a Tx UE may provide signaling or message to inform a Tx UE of no data reception. In one embodiment, the SL DRX configuration includes a transmission pattern, and the Tx UE sends an indication to inform the Rx UE that he will not transmit in his own transmission resources configured in his own SL DRX configuration. After receiving this indication, the Rx UE may skip monitoring for the corresponding reception resource from the Tx UE. In another embodiment, the SL DRX configuration includes a reception pattern, the Tx UE sends an indication to inform the Rx UE of that it will not transmit data in the reception resource configured in the SL DRX configuration of the peer UE. After receiving this indication, the Rx UE may skip monitoring for the corresponding reception resource from the Tx UE. In addition, upon reception of this indication, the Rx UE may wait for a while before stopping the reception, which can secure the reception on all ongoing HARQ processes to be completed. Such waiting time can be controlled based on a timer or time duration (pre-)configured or specified.

The signaling or message to inform the Rx UE of no data reception can be in several forms. In one embodiment, the Rx UE do not expect any (more) data in the current repetition cycle of the transmission pattern of the peer UE. In one embodiment, upon receiving the indication, receiver UE does not expect any reception from the Tx UE in the following/coming n transmission pattern cycle, where n is an integer. In one embodiment, the indication indicates a period of time (e.g. in unit of slots, subframes, or frames, etc.) within which duration the Rx UE is not expected to receive any data from the Tx UE.

Specific set of time-frequency resource can be configured for the Tx UE to instruct the monitoring behavior of the Rx UE, e.g., to indicate whether the Rx UE needs to wake up to monitor the reception pattern in one or more repetition cycles. If the Rx UE does not receive the indication, the Rx UE can skip the reception pattern in one or more repetition cycles. In short, we may call this indication a wake-up signal. Introducing the wake-up signal may have significant power saving gain, especially when the Tx UE has low packet arrival rate per repetition cycle of the transmission pattern, or when the Rx UE has long reception pattern per repetition cycle. For example, In SL relay scenario, a relay UE may have multiple remote UEs to transmit data and thus, the relay UE (e.g., the Tx UE) may select a relatively long transmission pattern, which means that the remote UEs (e.g., Rx UE) may need to monitor a longer reception pattern per repetition cycle. Another example is that, for latency-sensitive traffic, the repetition cycle of the reception pattern may be relatively short, and thus in time domain, the reception pattern may occupy a large portion of each repetition cycle. Alternatively, we may call this indication a go-to-sleep signal. That is, if the Rx UE receives this go-to-sleep signal from the Tx UE, the Rx UE can go to sleep for power saving in current or upcoming DRX pattern(s). Otherwise, if the Rx UE does not receive this go-to-sleep signal, the Rx UE should monitor current or upcoming DRX pattern(s), e.g., according to the SL DRX operation without this additional indication. The go-to-sleep signal, in contrast to the wake-up signal, is more suitable for the cases where the packet arrival rate per SL DRX pattern repetition cycle is quite high (e.g., probability more than 0.5). Based on the traffic arrival rate with its peer UE (e.g., the Rx UE), the Tx UE can select or be configured to use either the wake-up or go-so-sleep signal. Whether to use the wake-up or go-so-sleep signal can be configured statically (e.g. (re)configured via PC5-RRC message during SLRB establishment or PC5-RRC connection establishment, or (re)configured in a PC5-RRC message such as PC5-RRC reconfiguration message) or dynamically (e.g., via MAC CE configuration or via SCI indication). For example, a Tx UE may dynamically indicate in the L1 control signaling (e.g., SCI or PSCCH) whether this signaling functions as a wake-up or go-to-sleep signal, or dynamically indicate whether a Rx UE needs to wake up or not for the Tx UE that transmits the signal in current or upcoming repetition cycle of the transmission pattern. The time-frequency radio resources for the wake-up signal and/or the go-to-sleep signal can be reserved by the configured grant from BS or UE.

In another embodiment, a Tx UE can select or can be configured to use the wake-up or go-so-sleep signal based on the traffic arrival rate with its peer UE.

The configuration of the wake-up or go-to-sleep signal may depend on how SL DRX configuration works. To be more specific, if a UE exchanges its transmission pattern with its peer UE, the granularity of the wake-up or go-to-sleep signal can be with the same granularity as the transmission pattern. For example, for unicast service, the wake-up or go-to-sleep signal can be configured per unicast link, or per PC5-RRC connection, or per UE (same as the granularity of the transmission pattern in the SL DRX operation as mentioned before). For groupcast/broadcast service, the wake-up or go-to-sleep signal can be configured per groupcast/broadcast service (same as the granularity of the transmission pattern in the SL DRX operation as mentioned before). Similarly, if a UE exchanges its reception pattern with its peer UE for SL DRX operation, the granularity of the wake-up or go-to-sleep signal can be with the same granularity as the reception pattern. For example, for unicast service, the wake-up or go-to-sleep signal can be configured per unicast link, or per PC5-RRC connection, or per UE same as the granularity of SL DRX reception pattern.

The configuration of resource for the wake-up or go-to-sleep signal can be realized in several approaches.

In one approach, the wake-up/go-to-sleep resource (i.e., the resource configured for the wake-up/go-to-sleep signal) is configured per Tx UE. For example, for unicast service, the (standalone) SCI for the wake-up or go-to-sleep signal transmitting in (one of) the applicable resources includes the source UE ID and a bitmap (to identify the destination UE for a unicast link). In this case, each Rx UE (i.e., the peer UE of the Tx UE) monitors the resource of the Tx UE for transmission of the wake-up or go-to-sleep signal. If a Tx UE has very different transmission patterns for different links/peer UEs, its peer UE for a link may only needs to monitor the nearest (several) wake-up/go-to-sleep occasion/resource before the start of the transmission pattern for this link. That is, the peer UE does not need to monitor all the wake-up/go-to-sleep occasion/resource for reception from the Tx UE. The peer UE may only need to monitor the wake-up/go-to-sleep resource which is the (several) ones closest to the (start of) transmission pattern. For groupcast or broadcast service, the wake-up/go-to-sleep resource can be just before or at the beginning of each transmission pattern. The Rx UE monitors the wake-up/go-to-sleep resource dedicated for the groupcast/broadcast service to determine whether there would be transmission in the transmission pattern.

In one approach, the wake-up/go-to-sleep resource is configured per Rx UE. For example, if a Tx UE has data to be transmitted to a Rx UE, the Tx UE sends a wake-up/go-to-sleep signal in the wake-up/go-to-sleep resource of this Rx UE. The Rx UE monitors its own wake-up/go-to-sleep resource, and wakes up as long as there is data to be received from any peer UE (e.g., the Tx UE).

In one approach, the wake-up/go-to-sleep resource is configured per link/connection (e.g., for unicast) or per destination ID (e.g., for groupcast/broadcast service). A UE may apply separate wake-up signal/go-to-sleep resources for different links/connections and different groupcast/broadcast services.

In one approach, the wake-up/go-to-sleep resource is configured per cast mode. For unicast service, the content transmitted on the wake-up/go-to-sleep resource may include the UE IDs of the destination UE and the source UE. For groupcast service, the content transmitted on the wake-up/go-to-sleep resource may include a groupcast ID to identify a groupcast service, and optionally the content can further indicate the subset of group members to keep awake for reception. For broadcast service, the content transmitted on the wake-up/go-to-sleep resource may include a broadcast ID to identify a specific broadcast service.

In one approach, the wake-up/go-to-sleep resource is configured mix per UE and per link/service configuration. For example, some wake-up/go-to-sleep resource is dedicated for a directional or unidirectional link (specific for a Tx UE ID and a Rx UE ID). Some wake-up/go-to-sleep resource is dedicated to a Tx UE (e.g,. a Tx UE can use the wake-up/go-to-sleep resource to wake up several peer UEs for unicast or a subset of group members for groupcast). Some wake-up/go-to-sleep resources are dedicated for a Rx UE, and for instance, all Tx UEs, if they have data for transmission to the Rx UE, can send indication on the wake-up/go-to-sleep resource of the Rx UE to keep the Rx UE awake). A UE can be simultaneously configured with several Tx UE specific, Rx UE specific, link specific, or cast type specific wake-up/go-to-sleep resources.

In one approach, there may be no specific wake-up/go-to-sleep resource, i.e., all the required information is included in the content of the wake-up/go-to-sleep signal. In one example, a transmitter UE may send an SCI or a MAC PDU (on the PSSCH) which includes the UE ID of the Rx UE that should keep awake or sleep. In one example, a Tx UE may send the go-to-sleep signal to a Rx UE when the Tx UE has no more data for an awake Rx UE to receive. In one embodiment, a Tx UE can send the go-to-sleep signal during the sensing pattern of the Rx UE to inform the Rx UE that the Tx UE will not transmit data to the Rx UE in in the coming reception pattern of this Rx UE.

When a UE is informed of stopping data reception (e.g., the UE receives a go-to-sleep signal) from its peer UE, the UE may also prefer to stop transmission to the peer UE (e.g., if there is no more data for transmission to the peer UE). In one embodiment, the UE can reply a response message (e.g., in the form of a go-to-sleep signal, a message carried by SCI or MAC CE) to the peer UE. After (a period of time subsequent to) the signaling exchange, the ongoing communication may be terminated (or may continue in the next repetition cycle of the transmission or reception pattern). In one embodiment, the UE may not need to reply with any response message, and just stop transmission and reception in the current repetition cycle of the transmission or reception pattern.

Alternatively, when a UE is informed of stopping data reception by its peer UE, the UE may still has data to transmit. In one embodiment, the UE may continue to send data. In one embodiment, UE may stop transmission even if there is still data waiting to be transmitted. The UE behaviors when there is data to transmit may depend on the configuration, or the priority or latency requirement of data waiting to be transmitted.

FIG. 10 is a schematic diagram illustrating exemplary application of a wake-up signal during an SL DRX operation according to an embodiment of the application. The Tx UE is configured with Tx UE specific wake-up resource, on which the Tx UE can indicate which peer UEs (i.e., Rx UEs) have data to receive. The transmission pattern repeats per cycle. In cycle 1, the Tx UE sends out wake-up signals to indicate that both Rx UE 1 and Rx UE 2 have data for reception. In response to the wake-up signals, both Rx UEs should keep awake during the configured SL DRX period. In cycle 2, only Rx UE 2 has data to receive and thus, the Tx UE only sends out a wake-up signal to the Rx UE 2, so that the Rx UE 2 keeps awake for reception. In cycle 3, no Rx UE has data to receive, and thus, the wake-up signal is not transmitted at all, so that both the Rx UE 1 and Rx UE 2 can turn off their radios during the SL DRX reception period to save power.

### Coexistence for UEs with Different SL DRX Capability

SL DRX would be a new feature in 3GPP Release 17. A problem to be considered is how a R17 UE supporting SL DRX coexist with a R16 UE which does not support SL DRX.

Without any specific design, when a R16 UE communicates with a R17 UE which supports and activates SL DRX operation, a R16 UE may transmit data to the R17 UE when the R17 UE is not in SL active time. Since R17 UE is sleeping, the R16 UE cannot receive sidelink HARQ feedback from the R17 UE. As a result, the R16 UE would retransmit the packets, or even consider the link to the R17 UE is broken. To be specific, when the number of continuously unreceived SL HARQ feedback is above a threshold, the transmitter UE (i.e. the R16 UE) should consider the sidelink to the R17 UE is broken and thus release the corresponding PC5-RRC connection to the R17 UE. To avoid such abnormal problem when introducing the SL DRX feature, issue of coexistence of a R16 UE and a R17 UE supporting SL DRX should be resolved.

For sidelink unicast transmission, this can be solved by UE capability exchange. For example, upon PC5-RRC connection establishment, the two UE may exchange their UE capability. After a R17 UE exchanges UE capability with a R16 UE, the R17 UE would not operate SL DRX so that it can communicate with the R16 UE normally , i.e. there is no risk for the R17 UE to loss packet transmitted because it keeps awake after receiving the UE capability from its peer UE.

However, for connection-less groupcast or broadcast communication, it is not possible for each UE to exchange UE capability with all peer UEs or group members monitoring the same groupcast or broadcast service. Thus, additional methods in addition to UE capability exchange are required to handle the coexistence of UEs supporting SL DRX and UEs not supporting SL DRX in case of groupcast and broadcast.

There are several approaches in addition to UE capability exchange to solve the coexistence issue.

In one embodiment, separate resource pools are configured for SL DRX and not for SL DRX. In this embodiment, a UE not supporting SL DRX is always required to monitor the resource pool(s) which does not support SL DRX. In contrast, what resource pool a UE supporting SL DRX should apply depends on the mode of its peer UE (for unicast) or the interested service (for groupcast/broadcast).

In one example of separate resource pools for SL DRX capable/incapable UEs, a UE supporting SL DRX performs SL DRX operation in the resource pool supporting SL DRX. That is, the UE can apply its SL DRX configuration on top of the Rx resource pool supporting SL DRX.

In one example of separate resource pools for SL DRX capable/incapable UEs, a UE supporting SL DRX should keep awake during the period of Rx resource pool supporting SL DRX. In this example, UE can turn off radio for power saving when it is out of the time period of Rx resource pool supporting SL DRX. In this example, the SL DRX operation is defined by the time configuration of resource pools supporting and not supporting SL DRX.

In one example of separate resource pools for SL DRX capable/incapable UEs, for SL unicast, if the peer UE is a SL DRX incapable UE, the SL DRX capable UE should apply the transmission and/or reception resource pools which do not support SL DRX to communicate with the peer UE. In contrast, if the peer UE support SL DRX as well, the SL DRX capable UE then apply the transmission/reception resource pools which support SL DRX to communicate with the peer UE.

In one example of separate resource pools for SL DRX capabled/incapabled UEs, for SL groupcast/broadcast, each groupcast or broadcast service is associated with an indicator to indicator whether this groupcast/broadcast service applies SL DRX or not.

There are several ways to configure the SL DRX enabled/disabled indicator for a groupcast/broadcast service.

In one embodiment, the indicator is provided by upper layer, e.g. the V2X layer informs the AS layer of a UE whether a groupcast/broadcast service is dedicated for UEs support SL DRX (e.g. whether the groupcast/broadcast service would apply SL DRX operation), or the groupcast/broadcast service is applicable for both UE supporting or not supporting SL DRX.

In one embodiment, whether a SL groupcast/broadcast service is SL DRX enabled or not is determined by a (pre-)configured rule in AS layer, which may also take QoS profile/parameters of this groupcast/broadcast into account. For example, if a groupcast/broadcast service has a very tight latency budget, UE may determine that this groupcast/broadcast service is SL DRX deactivated, so that a short latency can be guaranteed. Another example is that, if a groupcast/broadcast service aims for power-efficient operation e.g. for long-time regular data collection, the latency budget could be quite long and thus the SL DRX function should be enabled. The (pre-)configured AS rule to for a UE to determine whether a groupcast/broadcast service should be operated in SL DRX mode may be specified in pre-configuration (e.g. for an out-of-coverage UE), in SIB (e.g. for an in-coverage UE), or optionally via dedicated signaling (e.g. for a RRC_CONNECTED UE).

There are also several embodiments about how to use the SL DRX enabled/disabled indicator for a groupcast/broadcast service.

In one embodiment, if a SL groupcast/broadcast service is SL DRX enabled, a SL DRX capable UE apply the Tx/Rx resource pools dedicated for SL DRX to perform groupcast/broadcast transmission/reception. In contrast, a SL DRX incapable UE may also apply Rx resource pool dedicated for SL DRX to receive packets for this groupcast/broadcast services. If it is further specified that during the whole period of the Tx/Rx resource pool dedicated for SL DRX, all those SL DRX capable UEs should keep awake, then a SL DRX incapable UE can also transmit data in these resource pool dedicated for SL DRX.

In one embodiment, if a SL groupcast/broadcast service is SL DRX enabled, a UE who does not support SL DRX does not support the SL groupcast/broadcast service. That is, only a UE who supports SL DRX operation can support a SL groupcast/broadcast service with SL DRX enabled.

In one embodiment, if a SL groupcast/broadcast service is SL DRX disabled, a UE supports the SL groupcast/broadcast service regardless of whether the UE supports SL DRX operation or not.

As mentioned above, we can configure separate resource pools so that UEs in some resource pools does not apply SL DRX, and UEs in another part of resource pools apply SL DRX.

In addition to separate resource pools, another possible embodiment is that a resource pool is shared by UEs who perform SL DRX operation and UEs who does not support SL DRX operation. Here we call it a shared resource pool. Both a SL DRX capable UE and a SL DRX incapable UE can use the shared resource pool to perform sidelink communication.

In one embodiment about how to use a shared resource pool, all the resource pools that can be used by a SL DRX incapable UE are shared resource pools. That is, a SL DRX incapable UE can use each of applicable resource pool to communicate with a SL DRX capable/incapable UE or to support SL DRX activated/deactivated groupcast/broadcast service.

In one embodiment about how to use a shared resource pool, for a SL DRX incapable UE, some resource pools are shared resource pools, while some resource pools are not shared resource pools, e.g. dedicated for SL DRX disabled operation. For example, when a SL DRX incapable UE wants to communicate with a SL DRX capable UE or to support SL DRX activated groupcast/broadcast service, it uses the shared resource pools. Otherwise, the SL DRX incapable UE uses other resource pools not supporting SL DRX for sidelink communication.

In one embodiment about how to use a shared resource pool, if the peer UE is a SL DRX capable UE as well, or if the interested groupcast/broadcast service is operating SL DRX, the SL capable UE performs SL DRX operation when using the shared resource pool. If the peer UE is a SL DRX incapable UE, or if the interested groupcast/broadcast service does not operate in SL DRX mode, the SL capable UE does not perform SL DRX when using this shared resource.

In one example about how to use a shared resource pool, if the peer UE is a SL DRX capable UE as well, or if the interested groupcast/broadcast service is operating SL DRX, a SL DRX capable UE does not uses the shared resource pool for sidelink communication. In other words, a SL DRX capable UE may use the shared resource pool only when it wants to deactivate SL DRX operation to coexist with peer UE not supporting SL DRX or to support a groupcast/broadcast service not operating in SL DRX mode. If the SL DRX capable UE wants to perform SL DRX for its sidelink communication, it uses other resource pools dedicated for SL DRX operation. For example, if a SL DRX capable UE wants to communicate with another SL DRX capable UE, they apply the Tx/Rx resource pool supporting SL DRX, and they can perform SL DRX operation (e.g. with specific time pattern to monitor the sidelink control channel discontinuously). In contrast, if a SL DRX capable UE wants to communicate with a SL DRX incapable UE, they apply the shared Tx/Rx resource pool not supporting SL DRX, and within the shared resource pool the SL DRX capable UE needs to continuously monitor the sidelink control channel.

In one example about how to use a shared resource pool, the time period of a shared resource pool is aligned with the (common) broadcast/groupcast SL DRX active time of groupcast/broadcast services. With this resource pool configuration, both a SL DRX capable UE and a SL DRX incapable UE can monitor the same broadcast/groupcast service normally. This is because by aligning the time period of shared resource pools with the common broadcast/groupcast SL DRX active time of groupcast/broadcast services, the transmission/reception time of a SL DRX incapable UE is reshaped as if this SL DRX incapable UE performs SL DRX operation like a SL DRX capable UE does.

While the application has been described by way of example and in terms of preferred embodiment, it should be understood that the application is not limited thereto. Those who are skilled in this technology can still make various alterations and modifications without departing from the scope and spirit of this application. Therefore, the scope of the present application shall be defined and protected by the following claims and their equivalents.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

1. A method, comprising:
maintaining Sidelink (SL) Discontinuous Reception (DRX) configuration by a User Equipment (UE), wherein the SL DRX configuration comprises one of a transmission pattern and a reception pattern that the UE expects to perform transmission and reception to a peer UE;
exchanging the S L DRX configuration with the peer UE;
based on the exchange of the SL DRX configuration, determining when to perform transmission or reception to or from the peer UE during an SL DRX operation; and
based on the determination, performing transmission or reception to or from the peer UE during the SL DRX operation.

2. The method as claimed in claim 1, wherein the transmission pattern comprises information indicative of a plurality of time-frequency radio resources that the UE uses to perform transmission to the peer UE, and the reception pattern comprises information indicative of a plurality of time-frequency radio resources that the UE uses to perform reception from the peer UE.

3. The method as claimed in claim 2, wherein the information comprises an SL DRX offset, an SL DRX-ON duration, and an SL DRX cycle.

4. The method as claimed in claim 1, wherein, for a unicast communication, the SL DRX configuration is maintained per unicast link or per PC5-Radio Resource Control (RRC) connection.

5. The method as claimed in claim 1, wherein, for a groupcast or broadcast communication, the SL DRX configuration is maintained per groupcast or broadcast service identified by a Layer-2 (L2) destination Identifier (ID), or per PC5 Quality of Service (QoS) flow associated with a QoS requirement.

6. The method as claimed in claim 1, wherein the SL DRX configuration is maintained per UE, and the UE applies the same SL DRX configuration for SL communications with all peer UEs.

7. The method as claimed in claim 1, wherein the SL DRX configuration is configured based on pre-configuration, or system information received from a base station, or dedicated signaling from the base station.

8. The method as claimed in claim 1, further comprising:
prior to the exchange of the SL DRX configuration, monitoring a set of time-frequency radio resources for reception of a discovery message from the peer UE.

9. The method as claimed in claim 8, wherein the set of time-frequency radio resources are configured based on pre-configuration, system information received from a base station, or L2 destination ID of the UE.

10. The method as claimed in claim 1, wherein the performed transmission comprises performing a first Transport Block (TB) transmission to the peer UE within the transmission pattern.

11. The method as claimed in claim 1, further comprising:
prior to performing the transmission to the peer UE, performing sensing on the Physical Sidelink Control Channel (PSCCH).

12. The method as claimed in claim 11, further comprising:
prior to performing the transmission to the peer UE, performing reception from the peer UE, wherein the performed reception and sensing are overlapped in time and frequency domains.

13. A User Equipment (UE), comprising:
a wireless transceiver, configured to perform transmission and reception to and from a peer UE; and
a controller, coupled to the wireless transceiver, and configured to:
maintain Sidelink (SL) Discontinuous Reception (DRX) configuration comprising one of a transmission pattern and a reception pattern that the UE expects to perform transmission and reception to a peer UE;
exchange the SL DRX configuration with the peer UE via the wireless transceiver;
based on the exchange of the SL DRX configuration, determine when to perform transmission or reception to or from the peer UE during an SL DRX operation; and
based on the determination, performing transmission or reception to or from the peer UE via the wireless transceiver during the SL DRX operation.

14. The UE as claimed in claim 13, wherein the transmission pattern comprises information indicative of a plurality of time-frequency radio resources that the UE uses to perform transmission to the peer UE, and the reception pattern comprises information indicative of a plurality of time-frequency radio resources that the UE uses to perform reception from the peer UE.

15. The UE as claimed in claim 14, wherein the information comprises an SL DRX offset, an SL DRX-ON duration, and an SL DRX cycle.

16. The UE as claimed in claim 13, wherein, for a unicast communication, the SL DRX configuration is maintained per unicast link or per PC5-Radio Resource Control (RRC) connection; or for a groupcast or broadcast communication, the SL DRX configuration is maintained per groupcast or broadcast service identified by a Layer-2 (L2) destination Identifier (ID), or per PC5 Quality of Service (QoS) flow associated with a QoS requirement; or the SL DRX configuration is maintained per UE and the UE applies the same SL DRX configuration for SL communications with all peer UEs.

17. The UE as claimed in claim 13, wherein the SL DRX configuration is configured based on pre-configuration, or system information received from a base station, or dedicated signaling from the base station.

18. The UE as claimed in claim 13, wherein prior to the exchange of the SL DRX configuration, the controller is further configured to monitor a set of time-frequency radio resources via the wireless transceiver for reception of a discovery message from the peer UE; and wherein the set of time-frequency radio resources are configured based on pre-configuration, system information received from a base station, or L2 destination ID of the UE.

19. The UE as claimed in claim 13, wherein the performed transmission comprises performing a first Transport Block (TB) transmission to the peer UE within the transmission pattern.

20. The UE as claimed in claim 13, wherein prior to performing the transmission to the peer UE, the controller is further configured to perform one or both of:
sensing on the Physical Sidelink Control Channel (PSCCH); and
reception from the peer UE;
wherein, when both the sensing and reception are performed, the performed sensing and reception are overlapped in terms of time-frequency radio resources.
